(19) United States
(12) Patent Application Publication
(10) Pub. No.: US 2021/0145556 A1
(43) Pub. Date: May 20, 2021

(54) ORAL IRRIGATOR TIP

(71) Applicant: Salvatore DeRicco, West Harrison, NY (US)

(72) Inventor: Salvatore DeRicco, West Harrison, NY (US)

(21) Appl. No.: 16/687,681

(22) Filed: Nov. 18, 2019

(51) Int. Cl. A61C 17/02

(52) U.S. Cl. CPC A61C 17/0202; A61C 17/0211

(57) ABSTRACT

According to an exemplary embodiment, an irrigator tip having a base/connector portion, a proximal shaft portion, a distal shaft portion, and a nozzle portion—offset in multiple planes, for flushing/cleansing gum lines and around fixed dental prostheses, may be shown and described. The irrigator tip can have multiple curves, along its length—to provide improved reach/access and flushing/cleansing, and it may be comprised of a single, continuous construction or of multiple, coupled components.

### CROSS-REFERENCE TO RELATED APPLICATIONS

This application claims priority from U.S. Provisional Application No. 62/768,918, entitled “ORAL IRRIGATOR TIP” and filed on Nov. 18, 2018, which is hereby incorporated, by reference, herein.

### BACKGROUND

Human teeth are highly susceptible to inflammatory diseases known as gingivitis and periodontitis; dental implants are highly susceptible to inflammatory diseases known as peri-implant mucositis and peri-implantitis; these diseases can result in the loss of the supporting bone, which houses and retains both natural teeth and implants. Fixed dental prostheses may replace a single natural tooth crown or multiple natural tooth crowns, and are anchored to and supported by natural teeth and/or dental implants. These fixed prostheses may then potentially obstruct the ideal access desired to permit adequate cleansing of their supporting teeth and/or implant(s), thereby permitting gingivitis, periodontitis, peri-implant mucositis and peri-implantitis—which begins at the gum line, to develop and progress. Oral irrigator tips are typically not well-proportioned or contoured to adequately and effectively reach/access and flush/cleanse the most complex and extensive fixed dental prostheses and/or their supporting natural teeth and/or implants, and their respective gum lines.

Oral health is an important component to overall health, since periodontal and peri-implant diseases are highly correlated with many serious and potentially fatal diseases, including heart, lung, kidney, liver, and pregnancy diseases, diabetes, and even tumors, to name a few. As such, the use of oral hygiene implements—beginning with toothbrushes and dental floss—to maintain good oral health, is routinely understood and accepted. However, due to physical restrictions and/or limitations, toothbrushes and dental floss may prove insufficient to adequately access all areas of the mouth and around all natural teeth, dental implants, and/or fixed dental prostheses, and/or fixed orthodontic appliances, so oral irrigators were developed—as supplemental devices, to flush away food debris and dental plaque.

Typical irrigator tips have a single straight shaft and a single “pre-nozzle” bend/elbow of approximately 20-45 degrees, which is adequate for flushing/cleansing around natural teeth—either without any supporting bone loss, or with mild or moderate loss of supporting bone. However, the positions of the gum line around natural teeth with severe amounts of supporting bone loss and/or around a large percentage of dental implants, is much further away from the “occlusal” (chewing) surfaces of their respective teeth and/or fixed prostheses, such that a typical irrigator tip—with a straight shaft and a single “pre-nozzle” bend/elbow cannot adequately reach/access and flush/cleanse that gum line.

### SUMMARY

According to an exemplary embodiment, an oral irrigator tip having a base/connector portion, a proximal shaft portion, a distal shaft portion, and a nozzle portion—offset in multiple planes, for flushing/cleansing gum lines and around fixed dental prostheses, may be shown and described. The oral irrigator tip may be hollow along its entire length, permitting the flow of irrigating fluids, from an oral irrigation unit or other fluid source, to the targeted intraoral areas. The oral irrigator tip may have multiple elbows/bends, along its length—to provide improved reach/access and flushing/cleansing, and it may be comprised of a single, continuous piece or of multiple, coupled components.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is an exemplary perspective drawing of an oral irrigator tip, showing my design

FIG. 2 is another exemplary perspective drawing of an oral irrigator tip, showing my design

FIG. 3 is an exemplary front drawing of an oral irrigator tip

FIG. 4 is an exemplary right side drawing of an oral irrigator tip

FIG. 5 is an exemplary top plan drawing of an oral irrigator tip

FIG. 6 is an exemplary drawing of an oral irrigator tip in use

FIG. 7 is another exemplary drawing of an oral irrigator tip in use

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Described herein are embodiments of an oral irrigator tip, for an oral irrigator. The oral irrigator tip can be formed in a variety of designs and utilize various combinations of bases, connector portions, shaft portions, nozzle portions, and elbows/bends to provide desired oral hygiene capabilities. The oral irrigator tip may include a hollow shaft, which includes a retention component for joining the oral irrigator tip to an oral irrigator unit—either to a hand-held irrigator unit or to the control handle of a countertop irrigator unit. The shaft may include a fluid inlet opening, a fluid outlet opening, and a fluid channel, with the fluid inlet opening communicating with a fluid reservoir of an oral irrigator unit and the fluid channel for passage of the fluid from the fluid inlet to the fluid outlet, for delivering a fluid stream from the oral irrigator tip. Fluid from the oral irrigator tip may be used to irrigate or otherwise cleanse a user's mouth. The shaft may be comprised of one continuous construction—from inlet opening to outlet opening, or may be comprised of two or more components, removably and/or non-removably attached to one another, and of either homogeneous or heterogeneous materials, which may each have the potential to pivot on the longitudinal axes of the shaft. An oral irrigator tip may be attached to an oral irrigator unit, to deliver a fluid stream, to clean the teeth, dental implants, and/or fixed dental prostheses of a user, and/or to irrigate the gingival sulci of teeth or the peri-implant crevices of dental implants.

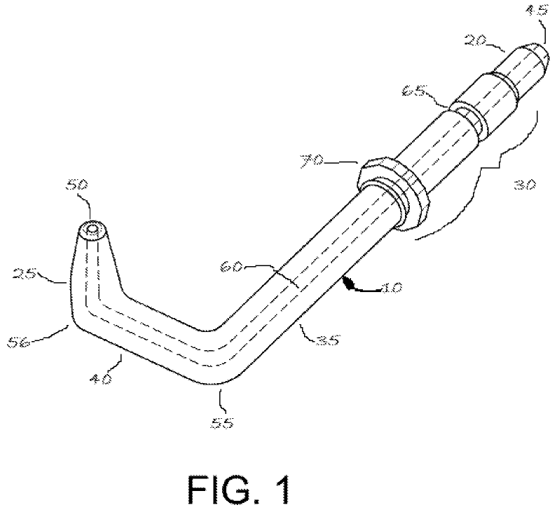

Referring now to exemplary FIGS. 1 & 2, two mirror-image embodiments of the oral irrigator tip 10 may take the form of a continuous construction, as shown. The oral irrigator tip may have a base portion 20 at one end—which houses a fluid inlet 45, a nozzle portion 25 at another end—which houses a fluid outlet 50, and a connector portion 30, a proximal shaft portion 35, and a distal shaft portion 40, in between. The shaft portions 35 & 40 and the nozzle portions 25 may be joined by elbows/bends 55 & 56, as shown in exemplary FIGS. 1 & 2. Total length of the oral irrigator tip may be 83 mm to 113 mm or more, as desired, and the lengths and proportions of the individual components may vary. The oral irrigator tip may be formed out of any of a variety of materials, including, but not limited to, plastics, composites, metals, or any other desired material.

Still referring to exemplary FIGS. 1 & 2, the two elbows/bends—from the proximal shaft portion 35 to the distal shaft portion 40 and from the distal shaft portion 40 to the nozzle portion 25 may be at any angle, and in any direction. For example, they may each be about 45-135 degrees, and their planes may be perpendicular to each other. As shown in FIGS. 1,2 and 3, the angle 55 formed between the proximal shaft portion 35 and the distal shaft portion 40 may be approximately 90 degrees, and, as shown in FIGS. 1,2 and 5, the angle formed between the distal shaft portion 40 and the nozzle portion 25 maybe approximately 90 degrees. The curvatures may be adjusted or may otherwise be made during the formation of the oral irrigator tip, so that it remains at a fixed angle. It may be appreciated, however, that the curvature between components may vary between oral irrigator tips, for example, depending on a particular application or depending on the fixed dental prosthesis, with which the oral irrigator tip may be used. These angles may be formed by bending, injection moulding, blow moulding, or 3-D printing the oral irrigator tip, or by any other suitable process, as appropriate, for its given construction material, and either in one continuous construction or in multiple, removably and/or non-removably coupled components, including, but not limited to press-fit, threaded, o-ring, clamped, adhered, and welded unions. In some embodiments, substantially detachable components may be capable of being swiveled/pivoted—to provide for maximal reach/access to otherwise inaccessible areas. Also, one distal shaft portion 40 and nozzle portion 25 of an oral irrigator tip 10 may be replaced by a different distal shaft portion 40 and nozzle portion 25, having a different elbow/bend angle 56. Such applications may be beneficial for use or treatment with different types of fixed dental prostheses, or for providing improved access for an intended user. Further, the base 20, connector portion 30, shaft portions 35 & 40, and nozzle portion may be formed in any shape. For example, the base/connector portion 20 & 30, shaft portions 35 & 40, and nozzle portion 25 may have a cylindrical, circular, rounded, rectangular, or square cross-sectional shapes, or a combination, thereof, and the nozzle portion 25 may be tapered or non-tapered, so as to provide for effectiveness and comfort during use, in a mouth.

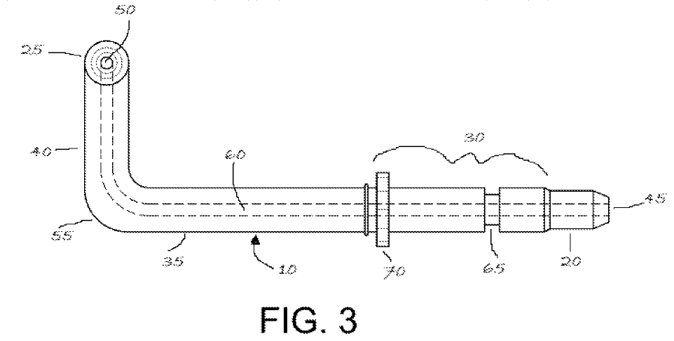

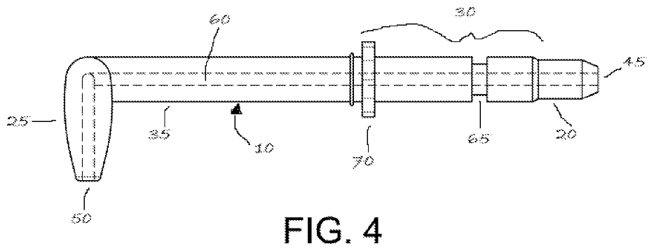

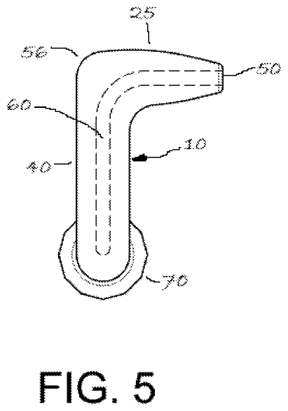

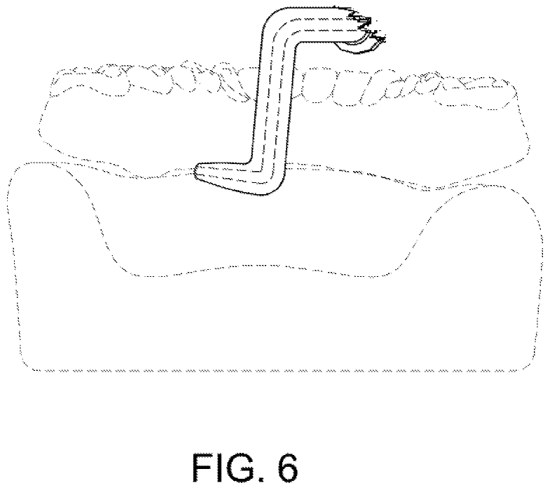

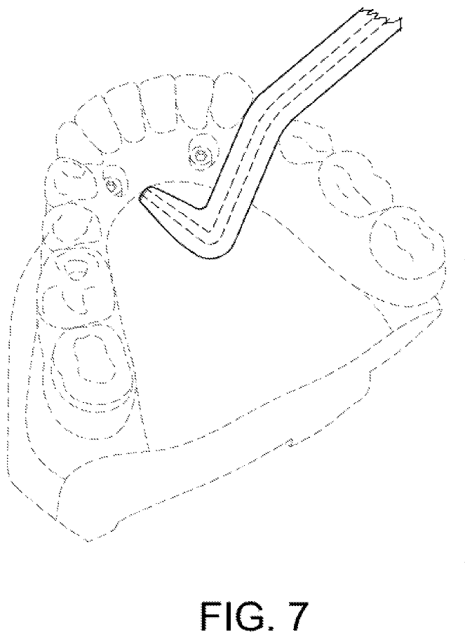

Referring to exemplary FIGS. 3-5, the irrigator tip 10 may have a distal shaft portion 40 which departs from the longitudinal axis of the proximal shaft portion 35 and the base/connector portion 20 & 30 at a desired angle—for example, about 90 degrees, and a nozzle portion 25 which departs from the longitudinal axis of the distal shaft portion 40 at a desired angle—for example, also 90 degrees, and which may lie in a plane which is perpendicular with respect to the plane of the proximal shaft portion 35 and the base/connector portion 20 & 30—for enhanced utility, in navigating the mouth of an intended user. This can be further illustrated in exemplary FIG. 6, showing an oral irrigator tip 10 in use at the base of a fixed dental prosthesis—on the lingual aspect of the left posterior quadrant and in exemplary FIG. 7, showing an oral irrigator tip 10 in use at the base of a fixed dental prosthesis—on the lingual aspect of the anterior sextant. As demonstrated in these figures, the different oral irrigator tip orientations allow for the flushing/cleansing of fixed prostheses and dental implants, which could not have otherwise been cleansed as effectively, by the intended user. As shown in these exemplary figures, such a design/configuration can allow for the cleansing of teeth/fixed dental prostheses, which were previously inaccessible, to other oral irrigator tips.

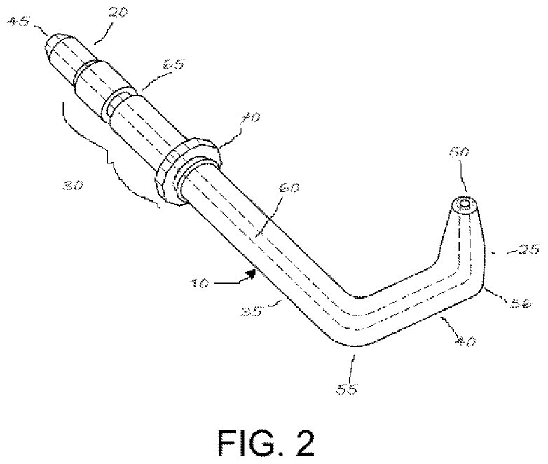

A retaining component 65 may be formed on the connector shaft portion 30, as shown in FIGS. 1-4. It may be in the form of a circumferential groove, for locking onto a protuberance on an oral irrigator, oral irrigator handle, or a coupler from another fluid source, including, but not limited to a faucet or shower head—via a coupler, or a flexible, fluid-containing bulb, thus permitting fluid to travel from the fluid source, into the fluid inlet 45, through the fluid channel 60, and out the fluid outlet 50, without the irrigator tip 10 being unintentionally disconnected. Alternatively, the retaining component may be in the form of a protuberance—to lock onto to the aforementioned types of fluid sources.

An anti-rotation component 70 may be formed on the connector shaft portion 30, to permit the control of the rotational position of the nozzle portion 25, around the longitudinal axis, of the proximal shaft 35, during use. This anti-rotation component 70 may be of a polygonal shape and mate with a recess of a matching polygonal shape within an oral irrigator, oral irrigator handle, or a coupler from an aforementioned alternative fluid source.

The foregoing description and accompanying figures illustrate the principles, preferred embodiments, and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art, without departing from the scope of the invention, as defined by the following claims.

What is claimed is:

1. An oral irrigator tip, comprising:
a shaft including an outlet opening and an inlet opening in fluid communication with the outlet opening.

2. The oral irrigator tip of claim 1, further comprising:
a shaft including a fluid channel; the shaft configured to provide fluid communication between an oral irrigator unit and the outlet opening.

3. The oral irrigator tip of claim 2 wherein the shaft comprises a base portion, a connector portion, a proximal shaft portion, a distal shaft portion, and a nozzle portion, linking the inlet opening to the outlet opening.

4. The oral irrigator tip of claim 2, wherein the shaft is configured to be removably coupled to an oral irrigator unit.

5. The oral irrigator tip of claim 4, wherein there is a bend between the proximal shaft portion and the distal shaft portion of 45-135 degrees, and said bend is away from the longitudinal axis of the proximal shaft portion and orients the distal shaft portion in the same plane as a plane of the proximal shaft portion.

6. The oral irrigator tip of claim 5, wherein there is a bend between the proximal shaft portion and the distal shaft portion of 90 degrees, and said bend is away from the longitudinal axis of the proximal shaft portion and orients the distal shaft portion in the same plane as a plane of the proximal shaft portion.

7. The oral irrigator tip of claim 4, wherein there is a bend between the proximal shaft portion and the nozzle portion of 45-135 degrees, and said bend is away from the longitudinal axis of the distal shaft portion and orients the nozzle portion in a plane which is perpendicular to a plane of the proximal shaft portion.

8. The oral irrigator tip of claim 7, wherein there is a bend between the proximal shaft portion and the nozzle portion of 90 degrees, and said bend is away from the longitudinal axis of the distal shaft portion and orients the nozzle portion in a plane which is perpendicular to a plane of the proximal shaft portion.

9. The oral irrigator tip of claim 4, wherein the connector portion is removably attached to the proximal shaft portion.

10. The oral irrigator tip of claim 4, wherein the distal shaft portion is removably attached to the proximal shaft portion.

11. The oral irrigator tip of claim 10, wherein the distal shaft portion may pivot on the longitudinal axis of the proximal shaft portion.

12. The oral irrigator of claim 4, wherein the nozzle portion is removably coupled to the distal shaft portion.

13. The oral irrigator tip of claim 12, wherein the nozzle portion may pivot on the longitudinal axis of the distal shaft portion.

14. The oral irrigator tip of claim 4, wherein the connector portion comprises a retaining component.

15. The oral irrigator tip of claim 14, wherein the retaining component comprises a recess.

16. The oral irrigator tip of claim 4, wherein the shaft portion comprises an anti-rotation component.
